(19) United States
(12) Patent Application Publication
(10) Pub. No.: US 2026/0107104 A1
(43) Pub. Date: Apr. 16, 2026

(54) AUDIO PLAYBACK METHOD, AUDIO PLAYBACK SYSTEM, AND TRANSMITTING SPEAKER

(71) Applicant: Realtek Semiconductor Corporation, Hsinchu (TW)

(72) Inventor: Tzu-Hsuan WENG, Hsinchu (TW)

(21) Appl. No.: 19/358,433

(22) Filed: Oct. 15, 2025

(30) Foreign Application Priority Data
Oct. 15, 2024 (TW) 113139201

(51) Int. Cl. H04S 7/00; H04R 3/12

(52) U.S. Cl. CPC H04S 7/301; H04R 3/12; H04R 2420/07; H04S 2400/01; H04S 2400/15

(57) ABSTRACT

An audio playback method comprises following steps of: (a) successively executing multiple beacon transmissions by a wireless communication chip, wherein the beacon transmissions are configured to transmit multiple corresponding timestamps, respectively; (b) capturing, by a system on chip, multiple corresponding system time points respectively corresponding to the beacon transmissions, in response to the beacon transmissions; and (c) generating a single time difference for all beacon transmissions, with each beacon transmission corresponding one-to-one with the respective timestamps and system time points. The step (b) comprises: when executing each of the beacon transmissions, sending, by the wireless communication chip, an input/output signal and a corresponding timestamp currently-transmitted to the system on chip through an input-output interface and a communication interface, respectively, to trigger a system interrupting; and capturing, by the system on chip, a current system time point as a corresponding system time point corresponding to a current beacon transmission.

### RELATED APPLICATIONS

This application claims priority to Taiwan Application Serial Number 113139201, filed on Oct. 15, 2024, which is herein incorporated by reference in its entirety.

### BACKGROUND

### Technical Field

Embodiments described in the present disclosure relate to an audio technology. More particularly, the embodiments described in the present disclosure relate to a playback method, an audio playback system and a transmitting speaker.

### Description of Related Art

In previous practices, creation of a stereo surround sound effect can be achieved by multiple speakers playing back the same audio file simultaneously. In the prior art, multiple wireless communication speakers are communicably connected to a transmitting speaker that can be used as a wireless access point (AP), the transmitting speaker acts as a bridge for the multiple wireless communication speakers to transmit a wireless signal (which can be a beacon signal) containing co-playback time point information to each of the wireless communication speakers, and then the wireless communication speakers determine their playback time points based on the co-playback time point information. In this way, the playback time points of all the wireless speakers are unified.

However, the transmitting speaker itself should also play back an audio in sync with the wireless speakers. Under the hardware configuration of the existing transmitting speaker, this requires that the co-playback time point information is sent to a system on chip of the transmitting speaker through a bus (e.g., USB 2.0), and then the system on chip determines a playback time point of the transmitting speaker according to the co-playback time point information. The co-playback time point information is a timestamp captured when the wireless signal is transmitted. In other words, the co-playback information takes the timestamp of the wireless signal as a time standard, but is not a system time point of the system on chip. Therefore, it is necessary to align the system time point of the transmitting speaker with a time point marked by the timestamp, that is, to compensate for a difference between the system time point and the time point marked by the timestamp, so that the transmitting speaker can play back the audio in sync with other communication speakers according to the co-playback time point information. The time required for the bus transmission described above is often difficult to estimate and is non-negligible, causing that it is difficult to align the system time point of the transmitting speaker with the time point marked by the timestamp.

Therefore, the present disclosure seeks to develop an audio playback method in which a system time point of a transmitting speaker is aligned with a time point marked by a timestamp, and accordingly, provides an audio playback system and a transmitting speaker for allowing each speaker to play back a corresponding audio at a specified time point.

### SUMMARY

Following the above paragraphs, compared with the prior art described above, the embodiments of the present disclosure can provide an accurate pairing of a system time point and a beacon time point, so that a speaker can align the beacon time point with the system time point, and then each speaker can play back an audio at a specified time point. In various situations, the speakers can play back the same audio simultaneously, or play back different audios at respective specified time points.

Some embodiments of the present disclosure relate to an audio playback method. The audio playback method comprises following steps of: successively executing multiple beacon transmissions by a wireless communication chip, wherein the beacon transmissions are configured to transmit multiple corresponding timestamps, respectively; capturing, by a system on chip, multiple corresponding system time points which correspond to the beacon transmissions, respectively, in response to the beacon transmissions; generating a single time difference for all beacon transmissions, with each beacon transmission corresponding one-to-one with the respective timestamps and system time points; and determining, by the system on chip, a system playback time point according to the time difference. The capturing, by the system on chip, the multiple corresponding system time points which correspond to the beacon transmissions, respectively, in response to the beacon transmissions comprises: when executing each of the beacon transmissions, sending, by the wireless communication chip, an input/output signal and a corresponding timestamp currently-transmitted in the corresponding timestamps to the system on chip through an input-output interface and a communication interface, respectively, to trigger a system interrupting, wherein the input-output interface and the communication interface are included in the wireless communication chip; and in response to an interrupt signal triggered by the input/output signal, capturing, by the system on chip, a current system time point as a corresponding system time point which corresponds to a current beacon transmission in the beacon transmissions.

Some embodiments of the present disclosure relate to a transmitting speaker. The transmitting speaker comprises a wireless communication chip and a system on chip. The wireless communication chip comprises a first interrupt service routine, a first input-output interface, and a first communication interface. The first interrupt service routine is configured to notify the input-output interface to generate an input/output signal. The first input-output interface generates the input/output signal in response to the first interrupt service routine. The first communication interface is configured to send a timestamp. The system on chip comprises a second input-output interface, a second communication interface, an interrupt handler, a wireless communication driver program, and an audio playback program. The second input-output interface is electrically connected to the first input-output interface. The second communication interface is electrically connected to the first communication interface. The second input-output interface receives the input/output signal and triggers an interrupt signal to notify the interrupt handler, and then the interrupt handler initiates a capturing of a system time point. The wireless communication driver program is configured to receive the timestamp through the second communication interface. The audio playback program is configured to generate a time difference between the system time point and a time point marked by the timestamp, and to play back an audio at a system playback time point estimated based on the time difference.

Some embodiments of the present disclosure relate to an audio playback system. The audio playback system comprises a transmitting speaker and multiple receiving speakers communicably connected to the transmitting speaker, wherein the transmitting speaker is configured to emit a beacon including a timestamp, and the receiving speakers are configured to receive the beacon. The transmitting speaker comprises a wireless communication chip and a system on chip. The wireless communication chip comprises a first interrupt service routine, and a first input-output interface. The first interrupt service routine notifies the input-output interface in response to a beacon transmission, and the first input-output interface generates an input/output signal. The system on chip comprises a second input-output interface, a second interrupt service routine, and an audio playback system. The second input-output interface is electrically connected to the first input-output interface to receive the input/output signal to trigger an interrupt signal. The second interrupt service routine is configured to capture a system time point of the transmitting speaker in response to the interrupt signal. The audio playback program is configured to generate a time difference between the system time point of the transmitting speaker and a time point marked by the timestamp. The transmitting speaker determines a system playback time point according to the time difference and the timestamp.

### BRIEF DESCRIPTION OF THE DRAWINGS

The content of the present disclosure may be better understood with reference to the embodiments in the subsequent paragraphs and the following drawings:

FIG. 1 shows a schematic diagram of an audio playback system in accordance with some embodiments of the present disclosure;

FIG. 2 shows a schematic diagram of a transmitting speaker in accordance with some embodiments of the present disclosure;

FIG. 3A shows a flow chart of an audio playback method in accordance with some embodiments of the present disclosure;

FIG. 3B shows a flow chart of further details of a step in FIG. 3A in accordance with some embodiments of the present disclosure;

FIG. 4 shows a schematic diagram of a signal sending mode in the transmitting speaker in accordance with some embodiments of the present disclosure; and

FIG. 5 shows a flow chart of a signal sending mode in the transmitting speaker in accordance with other embodiments of the present disclosure.

### DETAILED DESCRIPTION

The spirit of the present disclosure will be clearly illustrated by the following diagrams and detailed descriptions, and those having ordinary skill in the technical field to which the present disclosure pertains, after understanding the embodiments of the present disclosure, may make alterations and modification based on the technologies taught in the present disclosure, without departing from the spirit and scope of the present disclosure.

The terms used herein are intended for describing specific embodiments only and are not intended to limit the present disclosure. As used herein, the singular forms such as “one”, “this”, “the”, “aforementioned” and “said” also include plural forms.

The terms “comprise”, “include”, “have”, “contain”, etc. used herein are all open terms, that is, they mean including but is not limited to.

As used herein, the terms “approximately”, “about”, “or so” or “substantially” should generally mean within 20%, 10%, or 5% of a given value or range. The numerical magnitudes given herein are approximate, meaning that the terms “approximately”, “about”, “or so” or “substantially” can be conjectured in the absence of an explicit stipulation.

The terms used herein, unless otherwise specified, usually have their ordinary meanings used in the field, in the context of the present disclosure and in the special contexts. Certain terms used to describe the present disclosure will be discussed below or elsewhere in the Description to provide additional guidance to those skilled in the art in the description of the present disclosure.

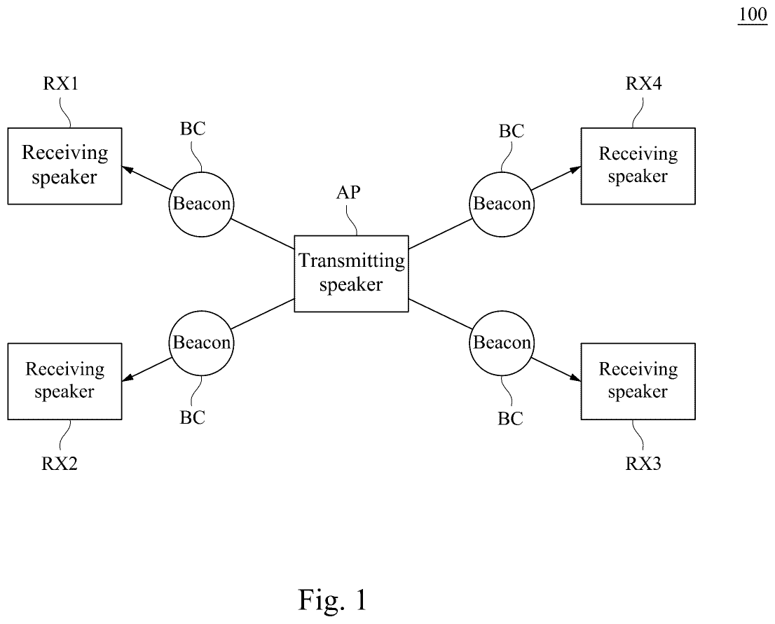

Now, reference is made to FIG. 1. FIG. 1 shows a schematic diagram of an audio playback system 100 in accordance with some embodiments of the present disclosure. As shown in FIG. 1, the audio playback system 100 includes a transmitting speaker AP and multiple receiving speakers RX1-RX4. The transmitting speaker AP is communicably connected to the receiving speakers RX1-RX4. Operationally, the receiving speakers RX1-RX4 receive a beacon signal BC emitted by the transmitting speaker AP, wherein the beacon signal BC includes a timestamp TSC related to a co-playback time point to further cause the transmitting speaker AP and the receiving speakers RX1-RX4 to play back synchronously. The receiving speakers RX1-RX4 continuously monitor wireless signals and actively receive the beacon signals BC.

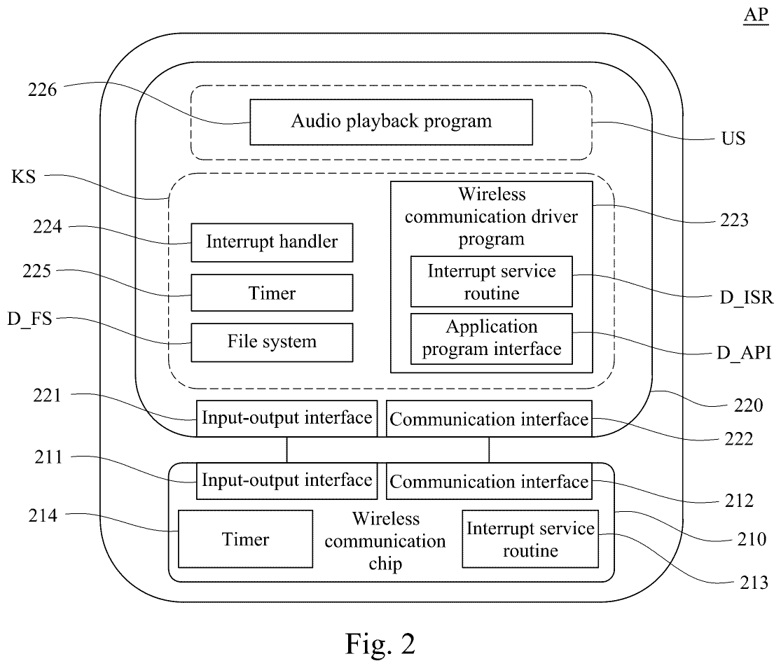

Now, reference is made to FIG. 2. FIG. 2 shows a schematic diagram of a transmitting speaker AP in accordance with some embodiments of the present disclosure. As shown in FIG. 2, the transmitting speaker AP includes a wireless communication chip 210 and a system on chip 220, wherein the wireless communication chip 210 may be, but is not limited to, a Wi-Fi chip. The wireless communication chip 210 includes an input-output interface 211 and a communication interface 212. The system on chip 220 includes an input-output interface 221 and a communication interface 222. The input-output interface 211 is electrically connected to the input-output interface 221. The communication interface 212 is electrically connected to the communication interface 222. In other words, the wireless communication chip 210 and the system on chip 220 are electrically connected to each other through the input-output interfaces 211 and 221 and the communication interfaces 212 and 222.

In some embodiments, the input-output interfaces 211 and 221 are general purpose input/output (GPIO) interfaces. In other words, the input-output interface 211 and the input-output interface 221 can be a GPIO pin and a GPIO port, respectively. In some embodiments, the communication interfaces 212 and 222 are universal serial bus (USB) interfaces. In other words, the communication interfaces 212 and 222 are a USB pin and a USB port, respectively.

In detail, the wireless communication chip 210 further includes an interrupt service routine (ISR) 213. The system on chip 220 further includes a kernel space KS and a user space US. Components in the kernel space KS can control parts of the hardware in the system on chip 220 by means of a machine code, i.e., a low-level programming language, and can directly extract system information, such as a system time point. In addition, the kernel space KS includes a wireless communication driver program 223 and an interrupt handler 224. The wireless communication driver program 223 includes an interrupt service routine D_ISR.

In contrast to the kernel space KS, components in the user space US cannot directly extract the system information and must make a request to the kernel space KS through a system call to extract the system information. The user space US includes an audio playback program 226. The specific functions and association relationships of the individual components of the wireless communication chip 210 and the individual components of the system on chip 220 are described together with an audio playback method 300 and signal sending modes 400 and 500 in the following paragraphs.

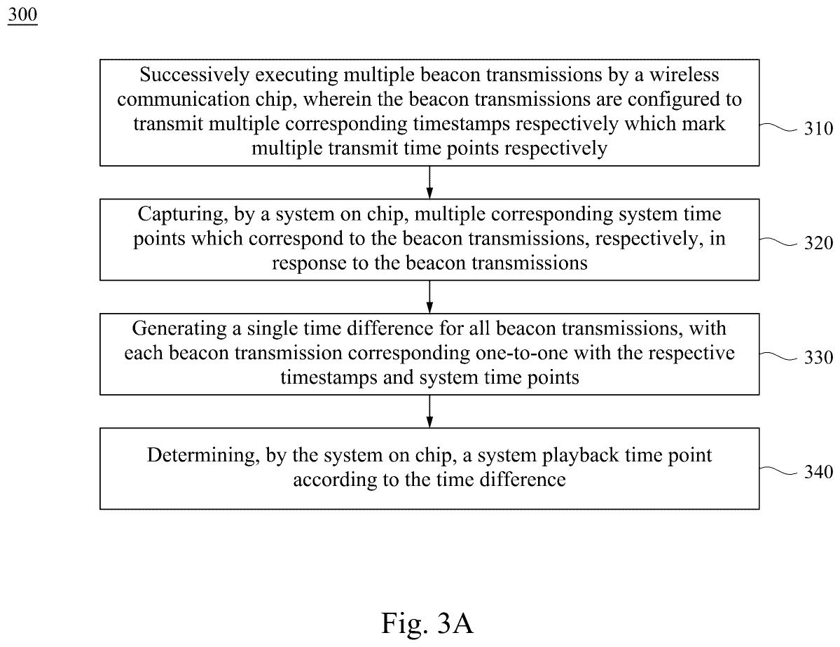

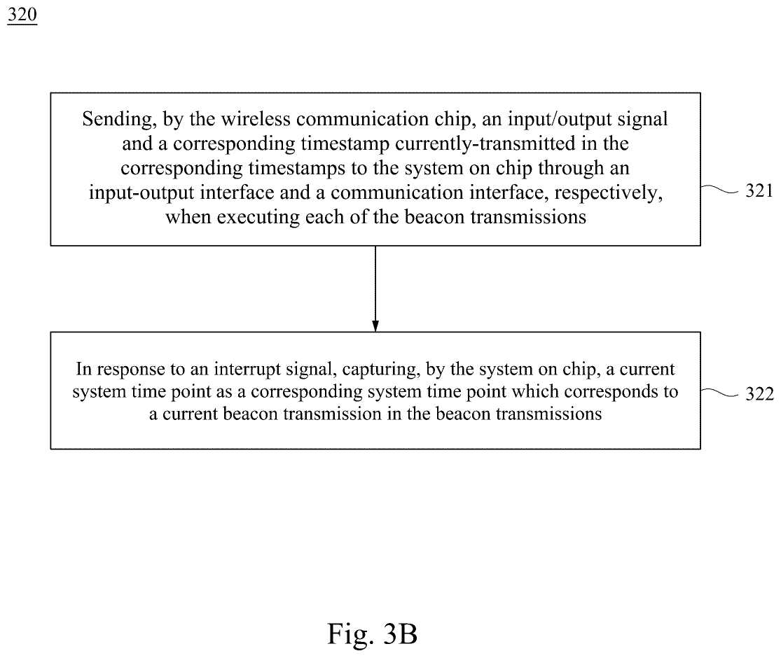

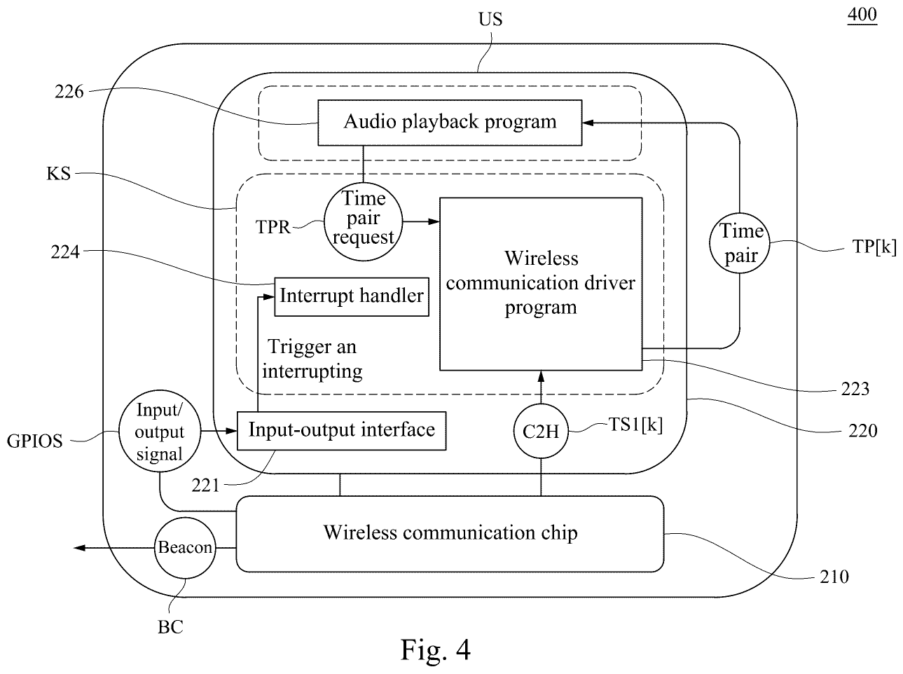

Now, reference is made to FIGS. 1, 2, 3A, 3B and 4 together. FIG. 3A shows a flow chart of an audio playback method 300 in accordance with some embodiments of the present disclosure. FIG. 3B shows a flow chart of further details of step 320 in FIG. 3A in accordance with some embodiments of the present disclosure. FIG. 4 shows a schematic diagram of a signal sending mode 400 in the transmitting speaker AP in accordance with some embodiments of the present disclosure. It should be understood that additional operations may be provided before, during and after the processes shown in FIGS. 3A and 3B, and that some operations described below may be substituted or eliminated for additional embodiments of the method. The order of the operations/processes can be interchangeable. In the drawings and illustrative embodiments, the same reference numerals are used to represent the same elements. The audio playback method 300 includes steps 310, 320, 330 and 340 below with reference to the signal sending mode 400, wherein step 320 includes substeps 321 and 322.

First, at step 310, multiple beacon transmissions BCT are successively executed by a wireless communication chip 210, wherein the beacons transmissions BCT are configured to transmit multiple corresponding timestamps TS1, respectively, and the corresponding timestamps TS1 respectively mark multiple transmit time points t1, t2, . . . , and tn. In other words, the wireless communication chip 210 executes the multiple beacon transmissions BCT in chronological order, so that the beacon transmissions are executed at different time points. In addition, as in the embodiment shown in FIG. 1, the beacon transmissions BCT will be received by the receiving speakers RX1-RX4.

For example, the beacon transmissions BCT include beacon transmissions BCT[1], BCT[2], . . . , and BCT[n], while the beacon transmissions BCT[1], BCT[2], . . . , and BCT[n] are transmitted at the transmit time points t1, t2, . . . , and tn, respectively. In addition, the beacon transmissions BCT correspond to the corresponding timestamps TS1 one by one. For example, the corresponding timestamps TS1 includes corresponding timestamps TS1[1], TS1[2], . . . , and TS1[n], wherein the corresponding timestamp TS1[1] corresponds to the beacon transmission BCT[1], the corresponding timestamp TS1[2] corresponds to the beacon transmission BCT[2], . . . , and the corresponding timestamp TS1[n] corresponds to the beacon transmission BCT[n].

In detail, as shown in FIG. 4, in each of the beacon transmissions BCT, the wireless communication chip 210 transmits a beacon signal BC to the outside of the transmitting speaker AP. The beacon signal BC includes a corresponding timestamp TS1[k]. The corresponding timestamp TS1[k] is a time stamp which corresponds to the current transmit time point tk and is captured from the wireless communication chip 210 when the beacon signal BC is transmitted. In other words, the corresponding timestamp TS1[k] corresponds to the current beacon transmission BCT[k], wherein the current beacon transmission BCT[k] is a beacon transmission performed at the current transmit time point tk. In addition, based on the above, at the transmit time point t1, the captured corresponding timestamp TS1[k] is the corresponding timestamp TS1[1]; at the transmit time t2, the captured corresponding timestamp TS1[k] is the corresponding timestamp TS1[2]; . . . ; at the transmit time point tn, the captured corresponding timestamp TS1[k] is the corresponding timestamp TS1[n]. In other words, the transmit time points t1, t2, . . . , tn are time points marked by the corresponding timestamps TS1[1], TS1[2], . . . , TS1[n], respectively. In addition, in some embodiments, the wireless communication chip 210 further includes a timer 214, and the corresponding timestamps TS1[1], TS1[2], . . . , TS1[n] are extracted from the timer 214.

At step 320, in response to the beacon transmissions BCT, multiple corresponding system time points SYsT which correspond to the beacon transmissions BCT respectively are captured by the system on chip 220. For example, the corresponding system time points SYsT include corresponding system time points SYsT[1], SysT[2], . . . , and SysT[n], wherein the corresponding system time point SYsT[1] corresponds to the beacon transmission BCT[1], the corresponding system time point SYsT[2] corresponds to the beacon transmission BCT[2], . . . , and the corresponding system time point SYsT[n] corresponds to the beacon transmission BCT[n]. In addition, in some embodiments, the system on chip 220 further includes a timer 225, and the corresponding system time points SYsT[1], SysT[2], . . . , SysT[n] are captured from the timer 225. In addition, in detail, step 320 includes substeps 321 and 322.

At substep 321, as shown in FIG. 4, when each of the beacon transmissions BCT is executed, the wireless communication chip 210 respectively sends an input/output signal GPIOS and the corresponding timestamp TS1[k] currently-transmitted in the corresponding timestamps TS1 to the system on chip 220 through the input-output interface 211 and the communication interface 212. In some embodiments, the input/output signal GPIOS is generated by the input-output interface 221 when each of the beacon transmissions BCT is executed.

For an interrupt signal, in detail, when each of the beacon transmissions BCT is executed, an interrupt service routine 213 of the wireless communication chip 210 first notifies the input-output interface 211, and then the input-output interface 211 generates the input/output signal (e.g., the input/output signal GPIOS shown in FIG. 4). For example, when the input-output interface 211 is a GPIO pin, accordingly, the interrupt service routine 213 notifies the input-output interface 211, and then the input-output interface 211 generates a pulse to the GPIO pin. The pulse is then sent from the input-output interface 211 to the input-output interface 221 (refer to FIG. 2), and the input-output interface 221 receives the pulse to trigger the interrupt signal to enter the interrupt handler 224 of the system on chip 220.

For the corresponding timestamp TS1[k], in detail, as shown in FIG. 4, the corresponding timestamp TS1[k] is included in a client to host (C2H) packet, and the C2H packet is sent through the communication interface 212 to the communication interface 222 (refer to FIG. 2) to enter the wireless communication driver program 223 of the system on chip 220, wherein the C2H packet has a packet structure different from that of general wi-fi packets. The C2H packet is unidirectionally sent from the wireless communication chip to the system on chip, while the wi-fi packet is sent between the wireless communication chips. By sending the C2H packet, the corresponding timestamp TS1[k] is sent to the wireless communication driver program 223.

In addition, in some embodiments, using the C2H packet to send the corresponding timestamp Ts1[k] is performed when the pulse acts as the input/output signal GPIOS to drive the GPIO interface 211. In other words, in response to an interrupt signal triggered by executing each of the beacon transmissions BCT, the generation of the input/output signal by the input-output interface 211 and the sending of the corresponding timestamp TS1[k] to the system on chip 220 through the communication interface 212 are performed simultaneously.

At substep 322, in response to the interrupt signal, the system on chip 220 captures the current system time point SysT[k] as a corresponding system time point which corresponds to the current beacon transmission BCT[k] in the beacon transmissions BCT. In other words, the current system time point is a system time point of the system on chip 220 captured in response to the current beacon transmission BCT[k] executed by the wireless communication chip 210 at the current transmit time point tk.

In detail, in some embodiments, as shown in FIG. 4, the interrupt handler 224, after receiving the interrupt signal, executes an interrupt service routine registered by the wireless communication driver program 223 of the system on chip 220. (refer to FIG. 2). Then, the interrupt service routine D_ISR captures the current system time point SYsT[k] as the corresponding system time point which corresponds to the current beacon transmission BCT[k]. In some embodiments, the wireless communication driver program 223, before starting performing a clock synchronization operation, has registered the interrupt service routine D_ISR with the interrupt handler 224. Therefore, the interrupt handler 224, after receiving the interrupt signal, directly executes the interrupt service routine D_ISR registered by the wireless communication driver program 223.

Then, at step 330, a single time difference for all beacon transmissions is generated, with each beacon transmission corresponding one-to-one with the respective timestamps and system time points.

In detail, the wireless communication driver program 223 further pairs the corresponding system time points Sys_T with the corresponding timestamps TS1 to generate multiple time pairs TP. In other words, Sys_T[1] and TS1[1] form a time pair TP[1]; Sys_T[2] and TS1[2] form a time pair TP[2]; . . . ; Sys_T[n] and TS1[n] form a time pair TP[n].

Then, the audio playback program 226 extracts the time pairs TP through the wireless communication driver program 223, wherein the time pairs TP include the time pairs TP[1], TP[2], . . . , and TP[n]. In detail, in some embodiments, as shown in FIG. 4, the audio playback program 226 issues a time pair request TPR to the wireless communication driver program 223, wherein the audio playback program 226 may issue the time pair requesting TPR at any time point. In response to the time pair request TPR, the wireless communication driver program 223 provides the current time pair TP[k] which corresponds to the current beacon transmission BCT[k] to the audio playback program 226. For each of the beacon transmissions BCT, the current time point TP[k] is provided to the audio playback program 226 in the same manner. In this way, the audio playback program 226 obtains the time pairs TP[1], TP[2], . . . , and TP[n].

In some embodiments, the audio playback program 226 issues the time pair request TPR at multiple predetermined time points to extract the time pairs TP. In some embodiments, there is a constant time interval delt_t1 between any adjacent two of the predetermined time points tp_1, tp_2, . . . , and tp_n. In other words, the time difference (tp_2−tp_1), the time difference (tp_3−tp_2), . . . , and the time difference (tp_n−tp_n−1) are the same. In another words, the audio playback program 226 periodically performs the extraction of the current time pair TP[k]. In some embodiments, there is a constant time interval delta_t2 between any adjacent two of the transmit time points t1, t2, . . . , tn for the beacon transmissions BCT. In other words, the beacon signal BC is transmitted periodically. In some embodiments, the time interval delta_t1 is equal to the interval delta_t2.

In addition, in more detail, in some embodiments, the wireless communication driver program 223 further includes an application program interface D_API (refer to FIG. 2). The time pair request TPR is transmitted to the application program interface D_API, and then the application program interface D_API provides the current time pair TP[k] to the audio playback program 226.

In some embodiments, the wireless communication driver program 223 does not include the application program interface D_API but further include a file system D_FS (refer to FIG. 2), e.g., proc entry. The time pair request TPR is transmitted to the file system D_FS, and then the file system D_FS provides the current time pair TP[k] to the audio playback program 226.

In some embodiments, the wireless communication driver program 223 further includes the application program interface D_API. The kernel space KS includes the file system D_FS (refer to FIG. 2). The time pair request TPR is optionally transmitted to the application program interface D_API or the file system D_FS, and then the application program interface D_API or the file system D_FS provides the current time pair TP[k] to the audio playback program 226, wherein the application program interface D_API is provided by the wireless communication driver program 223 itself, and the file system D_FS is registered from an operating system by the wireless communication driver program 223.

After the above operations are performed, step 330 is finally completed by the audio playback program 226 generating a single time difference for all beacon transmissions, with each beacon transmission corresponding one-to-one with the respective timestamps TS1 and system time points Sys_T.

At step 340, the system on chip 220 determines the system playback time point tp_sys according to the corresponding time pairs. In detail, according to the corresponding time pairs, the audio playback program 226 can calculate a time difference TD_f between a correct system time point and an emission time point marked by a timestamp. In some embodiments, the number of the beacon transmissions BCT before the operation of generating the corresponding time difference is performed is more than 20 to ensure that the time difference TD_f has sufficient accuracy.

In addition, an audio playback begins after the audio playback program 226 generates the time difference TD_f from the corresponding time pairs. For a period of time after the time difference TD_f is obtained, the audio playback system 100 does not need to perform a clock synchronization operation with the timestamp TSC of the beacon BC. The transmitting speaker AP actively transmits the beacon BC at a set interval (about 102.4 milliseconds). The content of the beacon BC includes the timestamp TSC. In some embodiments, the transmitting speaker AP continuously transmits the beacon BC, regardless of whether the clock synchronization operation is performed, so that the audio playback system 100 can perform the clock synchronization by means of this mechanism. When the audio playback is performed, as shown in FIG. 1, the transmitting speaker AP sends an audio AD to be played back (not shown) to the receiving speakers RX1-RX4. The audio AD includes a co-playback time point t_tsc.

Next, the audio playback program 226 determines a system playback time point tp_sys for playing back the audio AD according to the co-playback time point t_tsc and the time difference TD_f. In detail, the time difference Td_f is subtracted from the co-playback time point t_tsc to obtain the system playback time point tp_sys. Finally, the transmitting speaker AP plays back the audio AD at the system playback time point tp_sys. In addition, the receiving speakers RX1-RX4 also determine their respective AD playback time points according to the co-playback time point t_tsc.

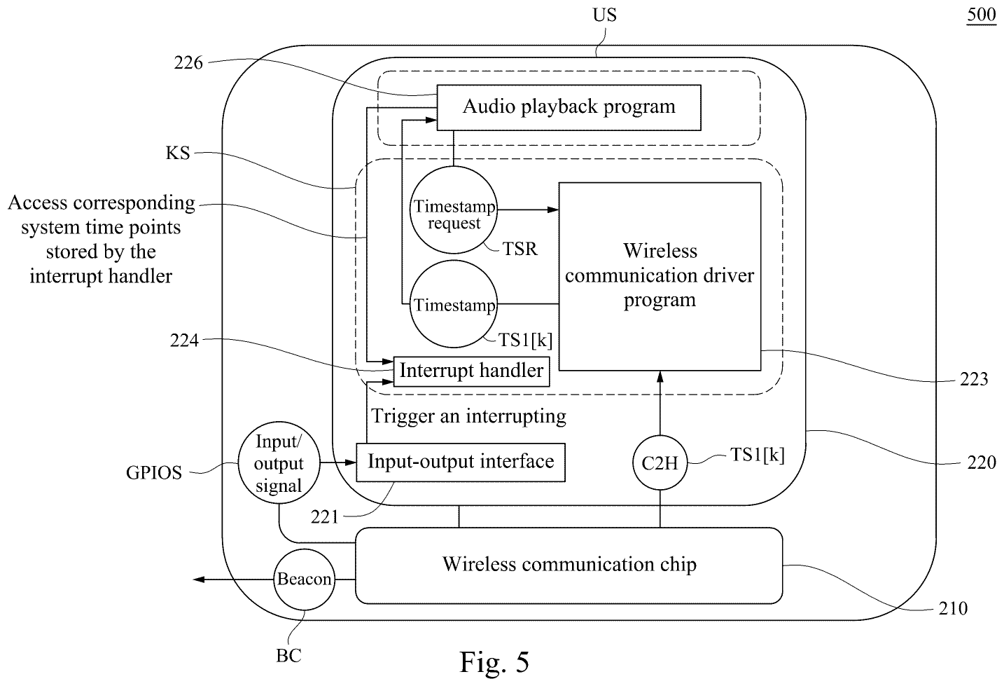

Now, reference is made to FIG. 5. FIG. 5 shows a flow chart of a signal sending mode 500 in the transmitting speaker according to other embodiments of the present disclosure. The audio playback method 300 can also be implemented in the signal sending mode 500. The audio playback method 300 implemented in a signal sending mode 400 differs from the audio playback method 300 implemented in the signal sending mode 500 in that the interrupt handler 224, instead of the wireless communication driver program 223, performs the operation of capturing the corresponding system time points Sys_T at substep 322, and the audio playback program 226 must obtain the corresponding timestamps TS1 from the wireless communication driver program 223 and obtain the system time points Sys_T from the interrupt handler 224, respectively. The other operations of the audio playback method 300 implemented in the signal sending mode 400 are not different from those of the audio playback method 300 implemented in the signal sending mode 500, and are therefore not detailed. The operation of capturing the corresponding system time points at substep 322 performed in the signal sending mode 500 and the operation of pairing the time pairs TP at step 330 performed in the signal sending mode 500 are detailed below.

With respect to the operation of capturing the corresponding system time points at substep 322 and the operation of pairing the time pairs TP at step 330, in some embodiments, as shown in FIG. 5, after the interrupt signal is received, the interrupt handler 224 captures the current system time point SysT[k] as the corresponding system time point which corresponds to the current beacon transmission BCT[k]. Next, the audio playback program 226 transmits a timestamp request TSR to the application program interface D_API or the file system D_FS of the wireless communication driver program 223. In response to the timestamp request TSR, the application program interface D_API or the file system D_FS sends the corresponding timestamps TS1 to the audio playback program 226. Next, the audio playback program 226 reads the system time points Sys_T obtained by the interrupt handler 224 and pairs the system time points Sys_T with the corresponding timestamps TS1 to generate multiple time pairs TP. In some embodiments, the audio playback program 226 requests the timestamps TS1 from the wireless communication driver program 223, and additionally accesses the system time points SysT captured by the interrupt handler 224 to make its own pairing.

Now, reference is made to FIG. 2. Based on the above operations, the specific functions and association relationships of the individual components of the wireless communication chip 210 and the individual components of the system on chip 220 are listed below. The interrupt service routine 213 is configured to notify the input-output interface 211. The input-output interface 211 is configured to generate the input/output signal GPIOS. The communication interface 212 is configured to send the timestamps TS1[1], TS1[2], . . . , or TS1[n]. The interrupt handler 224 is configured to receive the interrupt signal triggered by the input/output signal GPIOS received by the input-output interface 221 and initiates the capturing of a system time point. The wireless communication driver program 223 is configured to receive the timestamps TS1[1], TS1[2], . . . , TS1[n] through the communication interface 212. The interrupt service routine D_ISR is configured to perform the capturing of the system time point in response to a call from the interrupt handler 224 and to pair the system time points SysT[1], SysT[2], . . . , SysT[n] with the timestamps TS1[1], TS1[2], . . . , TS1[n]. The application program interface D_API and the file system D_FS are configured to provide the system time points and the timestamps which are paired to the audio playback program 226. The audio playback program 226 is configured to generate a single time difference from times pairs (system time points SysT[1], SysT[2], . . . , SysT[n] and the time points t1, t2, . . . , tn marked by the timestamps TS1[1], TS1[2], . . . , TS1[n]), and to play back the audio AD at the system playback time point tp_sys estimated based on the time difference.

In some embodiments, when each of the beacon transmissions BCT is executed, the input/output signal GPIOS and the corresponding timestamp TS1 currently-transmitted in the multiple corresponding timestamps TS1 are respectively sent by the wireless communication chip 210 to the system on chip 220 through the input-output interface 211 and the communication interface 212, to trigger a system interrupting when the system on chip 220 receives the input/output signal GPIOS.

In some embodiments, in response to the interrupt signal triggered by the input/output signal GPIOS, the system on chip 220 captures a current system time point as a corresponding system time point SYsT which corresponds to a current beacon transmission BCT[k] in the corresponding beacon transmissions BCT.

In some embodiments, the interrupt service routine 213 of the wireless communication chip 210 notifies the input-output interface 211 to generate the input/output signal GPIOS to the input-output interface 221, and in response to the input/output signal GPIOS, the system on chip 220 is triggered to generate the interrupt signal.

In some embodiments, the interrupt service routine 213 is configured to notify the input-output interface 211.

In some embodiments, the in response to the interrupt signal, capturing, by the system on chip 220, the current system time point SysT[k] as the corresponding system time point which corresponds to the current beacon transmission BCT[k] includes: executing, by the interrupt handler 224, the interrupt service routine D_ISR registered by the wireless communication driver program 223 of the system on chip 220, and capturing, by the interrupt service routine D_ISR, the current system time point SysT[k] as the corresponding system time point which corresponds to the current beacon transmission BCT[k].

In some embodiments, the corresponding timestamps TS1 are sent to the audio playback program 226 of the system on chip 210.

In some embodiments, the audio playback program 226 requests the corresponding timestamps TS1 from the wireless communication driver program 223, takes the corresponding system time points SYsT from the interrupt handler 224, and pairs the corresponding timestamps TS1 with the corresponding timestamps TS1 to generate multiple time pairs TP.

In some embodiments, the audio playback program 226 extracts the corresponding timestamps TS1 through the wireless communication driver program 223 and generates a single time difference TD according to the time pairs TP.

In some embodiments, the audio playback program 226 transmits the timestamp request TSR to the application program interface D_API or the file system D_FS of the wireless communication driver program 223, and in response to the timestamp request TSR, the application program interface D_API or the file system D_FS sends the corresponding timestamps TS1 to the audio playback program 226.

In some embodiments, the interrupt service routine 213 is configured to notify the input-output interface 211 to generate the input/output signal GPIOS. The input-output interface 211 generates the input/output signal GPIOS in response to the interrupt service routine 213.

In some embodiments, the input-output interface 221 receives the input/output signal GPIOS and triggers the interrupt signal, and the interrupt handler 224 initiates the capturing of the system time points SYsT.

In some embodiments, the interrupt service routine D_ISR is configured to perform the capturing of the system time points SYsT in response to a call from the interrupt handler 224, and to pair the system time points SYsT with the timestamps TS1.

In some embodiments, the interrupt service routine 213 notifies the input-output interface 211 in response to the beacon transmissions BCT. The input-output interface 211 generates the input/output signal GPIOS. The input-output interface 221 is electrically connected to the input-output interface 211 to receive the input/output signal GPIOS, to trigger the interrupt signal.

In summary, according to the present disclosure, the input-output interfaces 211 and 221 are added to the transmitting speaker AP to provide a channel between the wireless communication chip 210 and the system on chip 220 in addition to the communication interfaces 212 and 222. In such a configuration, the wireless communication chip 210 can send the input/output signal GPIOS to the input-output interface 221 through the input-output interface 211, to trigger an interrupt signal to notify the system on chip 220 to capture the system time points. The system time points do not need to be captured after the timestamps are sent through communication interfaces 212 and 222 to the wireless communication driver program 223, thereby solving the problem that the system time points of the transmitting speaker cannot align with the time points marked by the timestamps in the prior art. In this way, the audio playback system 100 can use the input/output signals GPIOS to timely provide accurate system time points SysT for being paired with beacon time points, thereby achieving an optimal alignment. The transmitting speaker AP can play back the audio AD within a specified period of time point.

Although the present disclosure has been disclosed as above in embodiments, the present disclosure does not preclude other possible embodiments. Therefore, the scope of protection of the present disclosure shall be as defined in the Claims below and shall not be limited by the foregoing embodiments.

Those skilled in the art may make some changes and embellishments within the spirit and scope of the present disclosure Based on the foregoing embodiments, all changes and embellishments made to the present disclosure also fall with the scope of protection of the present disclosure.

What is claimed is:

1. An audio playback method, comprising:
executing, by a wireless communication chip, a plurality of beacon transmissions, successively, wherein the plurality of beacon transmissions are configured to transmit a plurality of corresponding timestamps, respectively;
in response to the plurality of beacon transmissions, capturing, by a system on chip, a plurality of corresponding system time points which respectively correspond to the plurality of beacon transmissions, comprising:
when executing each of the plurality of beacon transmissions, sending, by the wireless communication chip, an input/output signal and a corresponding timestamp currently-transmitted in the plurality of corresponding timestamps to the system on chip through a first input-output interface and a communication interface, respectively, to trigger a system interrupting when the system on chip receives the input/output signal,
wherein the first input-output interface and the communication interface are included in the wireless communication chip; and
in response to an interrupt signal triggered by the input/output signal, capturing, by the system on chip, a current system time point as a corresponding system time point which corresponds to a current beacon transmission in the plurality of beacon transmissions;
generating a single time difference for the plurality of beacon transmission, with each beacon transmission corresponding one-to-one with the respective timestamps and system time points; and
determining, by the system on chip, a system playback time point according to the time difference.

2. The audio playback method of claim 1, further comprising:
when executing each of the plurality of beacon transmissions, generating, by the wireless communication chip, the input/output signal, comprising:
notifying, by an interrupt service routine of the wireless communication chip, the first input-output interface to generate the input/output signal to a second input-output interface; and
in response to the input/output signal, triggering the system on chip to generate the interrupt signal.

3. The audio playback method of claim 2, wherein the interrupt service routine is configured to notify the first input-output interface.

4. The audio playback method of claim 1, wherein the sending the corresponding timestamp currently-transmitted to the system on chip through the communication interface comprises:
including the corresponding timestamp currently-transmitted in a first packet; and
sending the first packet to the system on chip through the communication interface.

5. The audio playback method of claim 1, wherein the in response to the interrupt signal, capturing, by the system on chip, the current system time point as the corresponding system time point which corresponds to the current beacon transmission comprises:
executing, by an interrupt handler, an interrupt service routine registered by a wireless communication driver program of the system on chip, and capturing, by the interrupt service routine, the current system time point as the corresponding system time point which corresponds to the current beacon transmission.

6. The audio playback method of claim 1, wherein the in response to the interrupt signal, capturing, by the system on chip, the current system time point as the corresponding system time point which corresponds to the current beacon transmission comprises:
capturing, by an interrupt handler, the current system time point as the corresponding system time point which corresponds to the current beacon transmission.

7. The audio playback method of claim 6, wherein the plurality of corresponding timestamps are sent to an audio playback program of the system on chip; and the audio playback method further comprises:
requesting, by the audio playback program, the plurality of corresponding timestamps from a wireless communication driver program of the system on chip, taking the plurality of corresponding system time points from the interrupt handler, and pairing the plurality of corresponding system time points with the plurality of corresponding timestamps to generate a plurality of time pairs,
wherein the generating the corresponding time difference which corresponds to the plurality of beacon transmissions one by one, according to the plurality of corresponding timestamps and the plurality of corresponding system time points comprises:
extracting, by the audio playback program, the plurality of corresponding timestamps through the wireless communication driver program, and generating the corresponding time difference according to the plurality of time pairs.

8. The audio playback method of claim 7, wherein the audio playback program receives the plurality of corresponding timestamps from the wireless communication driver program, which comprises:
transmitting, by the audio playback program, a timestamp request to an application program interface or a file system of the wireless communication driver program; and
in response to the timestamp request, sending, by the application program interface or the file system, the plurality of corresponding timestamps to the audio playback program.

9. The audio playback method of claim 7, further comprising:
pairing, by the wireless communication driver program, the plurality of corresponding system time points with the plurality of corresponding timestamps to generate the plurality of time pairs,
wherein the generating the corresponding time difference which corresponds to the plurality of beacon transmissions one by one, according to the plurality of corresponding timestamps and the plurality of corresponding system time points comprises:
extracting, by the audio playback program, the plurality of time pairs through the wireless communication driver program, and generating the corresponding time difference according to the plurality of time pairs.

10. The audio playback method of claim 9, wherein the extracting, by the audio playback program, the time plurality of pairs through the wireless communication driver program is implemented at a plurality of predetermined time points, respectively.

11. The audio playback method of claim 10, wherein a first time interval is between any adjacent two of the plurality of predetermined time points.

12. The audio playback method of claim 11, wherein a second time interval is between any adjacent two of plurality of transmit time points, wherein the first time interval is equal to the second time interval.

13. A transmitting speaker, comprising:
a wireless communication chip, comprising:
a first interrupt service routine, configured to notify a first input-output interface to generate an input/output signal;
the first input-output interface, configured to generate the input/output signal in response to the first interrupt service routine; and
a first communication interface, configured to send a timestamp; and
a system on chip, comprising:
a second input-output interface, electrically connected to the first input-output interface;
a second communication interface, electrically connected to the first communication interface;
an interrupt handler, wherein the second input-output interface receives an input/output signal and triggers an interrupt signal, and the interrupt handler initiates a capturing of a system time point;
a wireless communication driver program, configured to receive the timestamp through the second communication interface; and
an audio playback program, configured to generate a time difference between the system time point and a time point marked by the timestamp, and to play back an audio at a system playback time point estimated based on the time difference.

14. The transmitting speaker of claim 13, wherein the wireless communication driver program comprises:
a second interrupt service routine, configured to perform the capturing of the system time point in response to a call from the interrupt handler, and to pair the system time point with the timestamp.

15. The transmitting speaker of claim 14, wherein the wireless communication driver program comprises:
an application program interface, configured to provide the system time point and the timestamp which are paired to the audio playback program.

16. The transmitting speaker of claim 14, wherein the wireless communication driver program comprises:
a file system, configured to provide the system time point and the timestamp which are paired to the audio playback program.

17. An audio playback system, comprising:
a transmitting speaker, configured to emit a plurality of beacon signals, wherein each of the plurality of beacon signals includes a timestamp, and the transmitting speaker comprises:
a wireless communication chip, comprising:
a first interrupt service routine, configured to notify a first input-output interface in response to a beacon transmission; and
the first input-output interface, configured to generate an input/output signal; and
a system on chip, comprising:
a second input-output interface, electrically connected to the first input-output interface to receive the input/output signal to trigger an interrupt signal;
a second interrupt service routine, configured to capture a system time point of the transmitting speaker in response to the interrupt signal; and
an audio playback program, configured to generate a time difference between the system time point of the transmitting speaker and a WiFi chip timestamp; and
a plurality of receiving speakers, communicably connected to the transmitting speaker, respectively, and configured to receive the plurality of beacon signals,
wherein the transmitting speaker determines a system playback time point according to the time difference.
